(19) United States
(12) Patent Application Publication
(10) Pub. No.: US 2019/0313822 A1
(43) Pub. Date: Oct. 17, 2019

(54) Moisture Control Mat

(71) Applicant: Tolco Corporation, Toledo, OH (US)

(72) Inventor: Alberto Martinez, Perrysburg, OH (US)

(73) Assignee: Tolco Corporation, Toledo, OH (US)

(21) Appl. No.: 16/382,612

(22) Filed: Apr. 12, 2019

Related U.S. Application Data
(60) Provisional application No. 62/657,346, filed on Apr. 13, 2018.

(51) Int. Cl. A47G 27/02; A47K 17/00; E03D 9/00; B32B 5/24

(52) U.S. Cl. CPC A47G 27/0206; B32B 5/24; E03D 9/00; A47K 17/00

(57) ABSTRACT

A moisture control mat that can be conveniently folded to reduce packaging size for the mat. The mat is particularity useful when placed adjacent urinals or toilets.

### CROSS REFERENCE TO RELATED APPLICATION

The present patent application is based upon and claims the benefit of provisional patent application No. 62/657,346, filed on Apr. 13, 2018.

### BACKGROUND OF THE INVENTION

The mat of the present invention is frequently used as an moisture control surface adjacent to a urinal or a toilet to assist in keeping the area around the urinal or toilet clean and dry. To effectively cover the necessary area adjacent to the urinal or toilet, it is necessary that the mat have a size that is relatively large. The size of the prior absorbent mat makes it difficult to package, ship, and store the absorbent mats in a convenient fashion. Such prior art absorbent mats do not fit in standard packages or containers that are used by most shipping companies. This results in increased fees for shipping the absorbent mats and this can significantly impact the commercial acceptability of the absorbent mats. The absorbent mats have a limited life span when used in public restrooms facilities and must be replaced frequently. Accordingly, the cost of the absorbent mats must be relatively low, or it is difficult to sell the absorbent mat to the intended users. In addition, the large size prior art absorbent mats are difficult to store, and this inconvenience further reduces the commercial desirability of such prior art absorbent mats. The prior art absorbent mats are also made from materials that absorb and retain the fluids that come into contact with the mat. By absorbing and retaining the fluids, the prior art mats remain wet, tend to curl at the edges and are unpleasant to dispose of when it is time to replace the mat. The mat of the current invention is designed to address these shortcomings of the prior art absorbent mats and to enhance the commercial viability of this type of product.

### DESCRIPTION OF THE DRAWINGS

FIG. 1 is a top view of the absorbent mat of the invention.

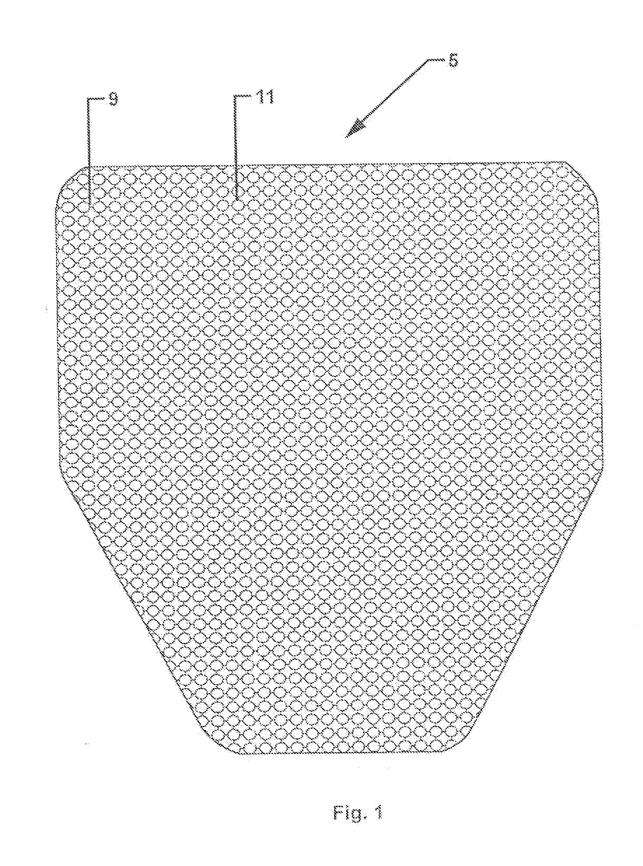

FIG. 2 is a bottom view of a folded mat.

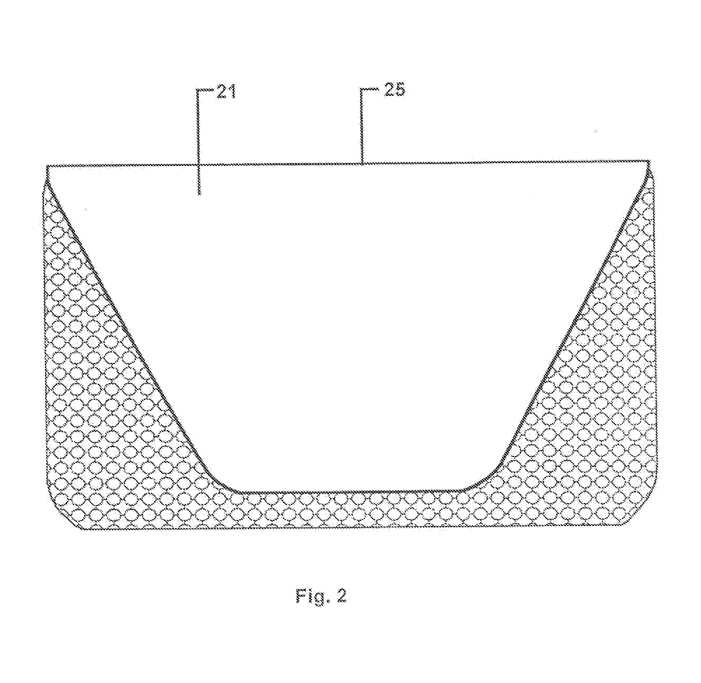

FIG. 3 is a top view of an alternative mat.

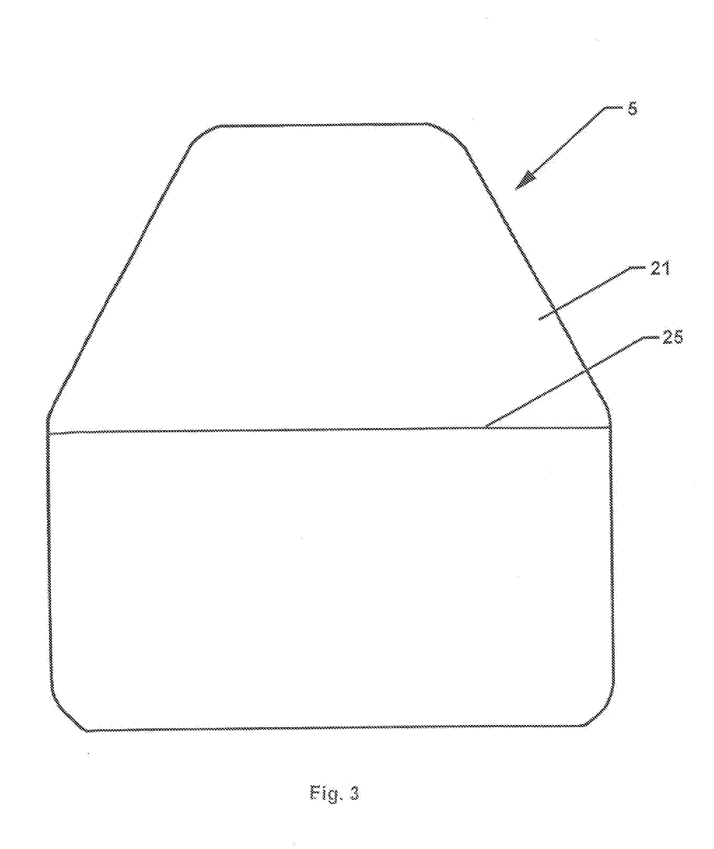

FIG. 4 is a partial cross-sectional view of the mat of FIG. 1.

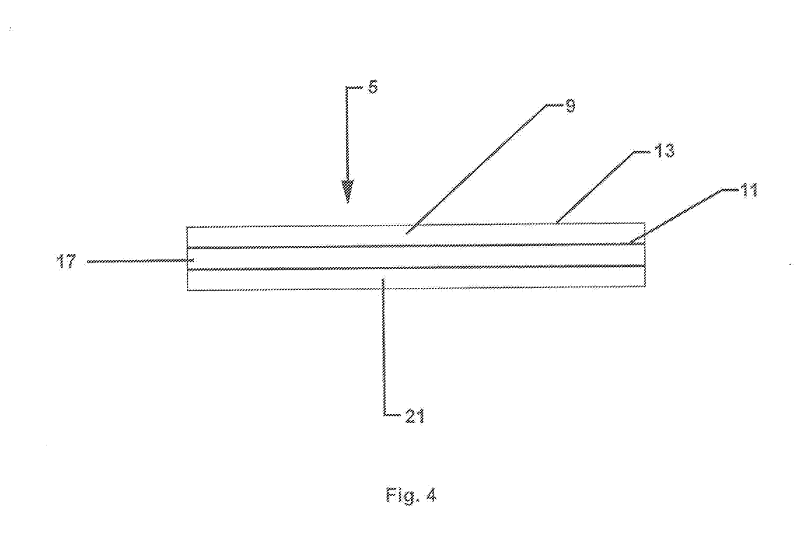

FIG. 5 is a bottom view of the absorbent mat.

FIG. 6 is a top view of the absorbent mat.

FIG. 7 is a bottom view of the absorbent mat.

FIG. 8 is a partial cross-sectional view of the mat of FIG. 6.

### DESCRIPTION OF THE INVENTION

The present invention is directed to an moisture control mat that can be conveniently folded to reduce the packaging size for the mat. The mat has many uses, but it is particularly useful when placed adjacent a urinal or toilet. Such mats are relatively large in size, are difficult to package, ship, and store as the size of the container of the mats is larger than most standard size shipping container. The large size of the mat can dramatically increase the cost of shipping the product and make the product too large to fit on normal store shelves or storage shelves in a facility where the mat is ultimately utilized. The present invention has created a way where the mat can be conveniently folded to at least half of its original size and this eliminates many of the problems associated with the commercial desirability of the prior art absorbent mat.

### DETAILED DESCRIPTION OF THE INVENTION

The moisture control mat of the present invention is frequently used adjacent to a urinal or toilet. More particularly, the mat of the present invention is constructed to fold to improve the commercial acceptability of the mat. The features of the invention will be more completely understood by referring to the following detailed description and to the attached drawings.

The moisture control mat 5 of the present invention is made from a non-woven layer 9 of fibers. The non-woven material for mat 5 can be selected from the group of polyester, polypropylene and similar synthetic material. The non-woven layer can also be a combination of the above fibers. It is preferred that the non-woven mat is made of polyester fibers. The non-woven layer has a thickness from about 20 mils to about 200 mils and a density from about 40 gsm to about 200 gsm. The fibers in the non-woven layer function to wick liquid around the mat to allow the maximum quantity of liquid to be affectively managed by the mat 5. The fibers that form the non-woven layers have a large surface area and liquid that comes into contact with the fibers is wicked along the surface of the fibers. This wicking action by the fibers distribute the liquid around the mat so that the mat can effectively handle the quantity of liquid normally associated with a urinal mat or similar product The fibers in the non-woven layer 5 do not absorb the liquid, but just hold the liquid on the surface of the fibers. The plurality of fibers in the non-woven layer can also provide a web of fibers that can hold a quantity of li quid on the surface of the fibers. The large surface area presented by the fibers in the non-woven layer allows any liquid on this layer to readily evaporate so that the liquid moves into the atmosphere and does not stay on the mat. In practice it has been found that liquid distributed by the wicking action of the non-woven layer will evaporate in a relatively short period of time to allow this product to effectively function to control the normal liquids encounter by a urinal mat. The non-woven layer has a first side 11 and a second side 13. An adhesive layer 17 is disposed on the first side of the non-woven layer. The adhesive layer is an acrylic emulsion or similar type of adhesive. The adhesive layer has a thickness from about 0.5 mils to about 4 mils. The adhesive layer covers at least a portion of the first side of the non-woven layer. The adhesive layer 17 is designed so that it bonds to the fibers of the non-woven layer 9. The adhesive layer 17 forms a liquid impervious or partially liquid impervious barrier, depending on the adhesive used, that resists liquid moving through the first side of the non-woven layer. The surface of the adhesive layer 17 that is spaced apart from the non-woven layer 9 is disposed to engage and secure the mat 5 to a surface. A release layer 21 is positioned on the side of the adhesive layer 17 that is spaced apart from the non-woven layer. The release layer 21 is removably positioned on the adhesive layer 17 to protect the adhesive layer and to keep the adhesive layer from bonding to surfaces before the absorbent mat 5 is positioned in the desired location. The release layer 21 is a plastic film such as white glassine or a silicone coated or based paper that will adhere but not bond to the adhesive layer 17 with a level of force that allows this layer to be easily removed from the adhesive layer. The release layer has a thickness from about 2 mils to about 4 mils. The release layer bonds to the adhesive layer with a degree of adherence that is considerable less than the degree of adherence that will be present when the adhesive layer is positioned on the surface where the absorbent mat 5 is to be ultimately positioned. The adhesive or bonding strength of the release layer is from about ¼ to about ½ of the bonding strength of the adhesive layer 17 to the surface where the mat is to be used.

At least one slit 25 is positioned in the release layer 21. The at least one slit is shown as extending along the horizontal center line of the absorbent mat 5 in the drawings. It should be appreciated that the at least one slit could be positioned in other locations in the release layer 21 and that more than one slit can be positioned in the release layer 21. The slit in the release layer 21 allows the absorbent mat to be easily folded along the slit and the horizontal axis so that the second side 11 of the non-woven layer 9 is folded over upon itself. This significantly reduces the size of the mat 5 and allows the mat to be placed in a normal sized container for shipping. In fact, several of the folded mats are normally positioned in the shipping container to be sent to the end user. The release layer 21 still covers the adhesive layer 17 to keep the adhesive layer from bonding to the adhesive layer on an adjacent mat or to the side of the container. The mat 5 can be unfolded when it is removed from the shipping and storage container, and the mat is then ready for use.

To use the moisture control mat, the release layer 21 is removed and the side of the adhesive layer that is spaced apart from the non-woven layer 9 is positioned in the desired location on the surface where the mat is to be used. The slit 25 in the release layer 21 provides a gripping area to assist in removing the release layer. The adhesive layer 17 bonds to the surface on which the mat is to be used and assist in the mat lying flat on the surface. The adhesive layer, when bonded to the surface where the mat is used, eliminates or substantially reduces any fold line from where the mat 5 was folded. The adhesive layer also bonds to the surface with a level of adhesion so that the mat will not move when used in a normal application. In addition, the surface around the mat 5 can be mopped for usual cleaning of the surface without the mat moving from its desired location. If the mat is mopped as part of the cleaning operation, any liquid from the mopping will wick along the fibers of the non-woven layer and evaporate into the atmosphere where the mat is located. When the mat 5 needs to be changed, the mat can be peeled away from the surface from where it is located as the adhesive layer 17 is designed to retain an absorbent mat in position on the surface without moving but at the same time have a level of adherence or bonding that allows the used mat to be easily peeled from the surface. Once removed, the mat 5 can be easily folded or otherwise made smaller, and easily discarded. The folded mat also takes up less space when discarded. The adhesive is designed to peel cleanly from floor, with no residue when the mat is removed.

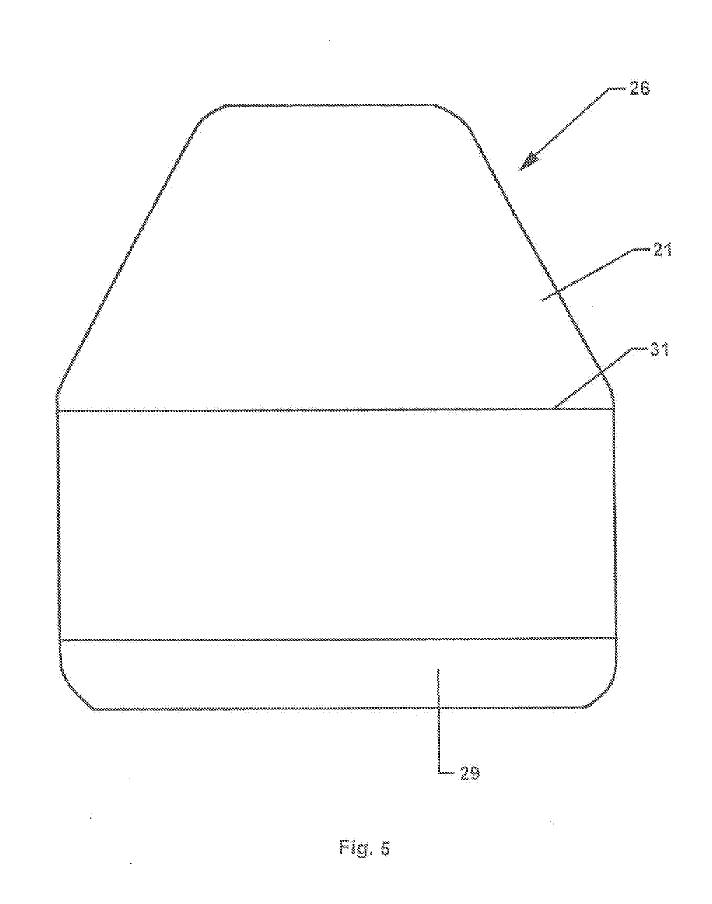

FIG. 5 shows another feature of the invention where the moisture control mat 26 is essentially the same as the mat 5, but without the at least one slit 26 in the release layer. In this configuration, the moisture control mat 26 can be folded in the manner previously described as the thickness of the mat is from about 10 mils to about 100 mils and can be folded without a slit in the release layer 21. The absorbent mat 26 has at least one fold line 31 defined on the release layer 21 to provide guidance for the preferred way to fold the mat. The at least one fold line can be a crease, mark, series of dimples or other marker that creates a fold area on the release layer. The thinness of the mat allows for the folding without producing an objectionable bump or seam in the mat. When the mat is unfolded and placed on a surface, the adhesive layer 17 will cause the mat to be bonded in a flat configuration on the surface as previously described. The mat 26 also has a strip 29 of the non-woven layer 9 position along one side of the mat 26 that does not contain an adhesive layer 17. The strip 29 is designed to be positioned adjacent to a wall under a urinal and will not be secured to the floor adjacent the urinal. The strip 29 has a width that is from about 0.5 of an inch to about 4 inches, with 1 inch to 2 inches preferred and usually extends across the entire width of the mat 26. Although the strip could have one or more areas that contain an adhesive. The strip 29 is designed to give a place where the mat can be gripped, lifted from the floor and used to peel the adhesive layer 17 on the rest of the mat from the floor so that the mat can be easily replaced when needed. It may only be necessary to have a portion of the strip 29, adjacent to each side of the mat not contain an adhesive as this would provide a gripping area on each side of the mat to allow the mat to be peeled from the floor. In addition, an adhesive with a lower bonding strength than the adhesive used in the adhesive layer could be applied to the strip 29. The lower bonding strength adhesive would allow the strip to be easily separated from the floor when it is time to remove the mat 26. As the strip is designed to be placed under the urinal adjacent to a wall, the strip is not located in an area that will be stood upon by the user of the urinal. Once removed, the mat is discarded as previously described.

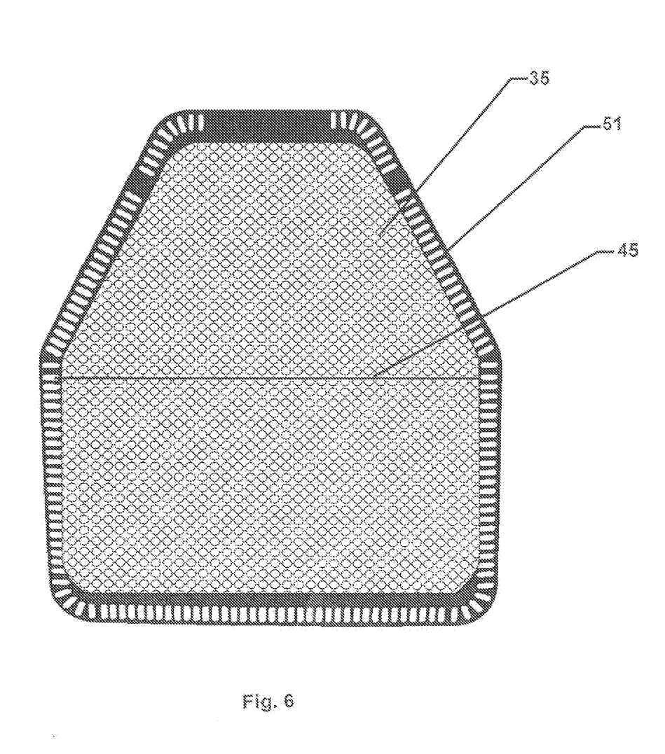

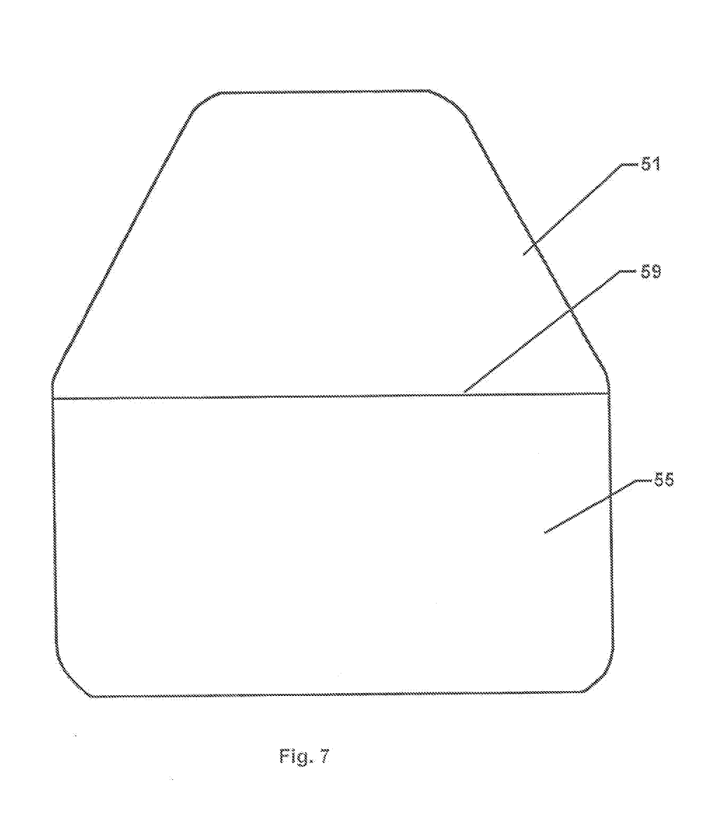

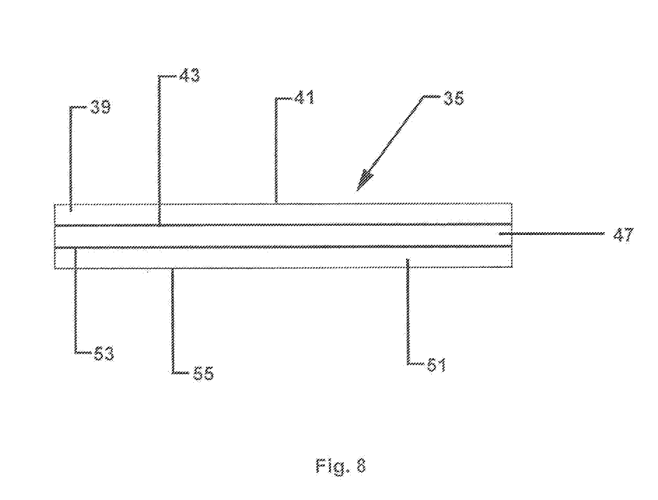

FIGS. 6, 7, and 8 show another feature of the invention where a moisture control mat 35 having a non-woven layer 39 and an adhesive layer 47, as previously described, is positioned in a plastic or rubber frame 51. The frame 51 has an outer periphery that is slightly larger than the outer periphery of the mat 35 and the outer periphery of the mat and the frame have essentially the same shape. The configuration of the mat 35 and the frame 51 allow the mat to be positioned in the frame 51. The frame 51 has a first surface 53 and a second surface 55. The first surface 53 is designed to receive the adhesive layer 47 that is positioned on the second side 43 of the non-woven layer 39 of the mat. The adhesive layer 47 is positioned on a substantial portion of the second side 43 and the adhesive layer bonds the mat 35 to the first surface 53 of the frame 51. The first side 41 of the non-woven layer is spaced apart from the first surface 53 of the frame 51 and provides a surface that is designed to wick and distribute liquids or fluids so that the liquids can evaporate from the mat. The second surface 55 of the frame 51 is disposed to be positioned on a surface where the mat 35 can be positioned to distribute and evaporate the fluids or liquids.

A fold line 59 is positioned on the second surface 55 of the frame 51. The fold line is usually positioned along a longitudinal, horizontal or any other desired axis of the frame 51 and allows the frame to be folded so that is essentially one half of the size of the frame when it is positioned on a surface to distribute and evaporate liquids. The fold line 59 is disposed so that the first surface 53 of the frame is folded towards each other and the mat 35 is retained between the folded portions of the frame 51. In this manner, the folded frame 51 protects the mat during shipping and handling prior to when the mat is positioned to distribute and evaporate liquids. To facilitate the folding of the frame and absorbent mat a fold zone 45 can be positioned in the non-woven layer 39 and the adhesive layer 47. The fold zone is designed to be in alignment with the fold line 59 and the frame 51 when the mat 35 is properly positioned on the frame 51. The fold line 59 can also be positioned on the first surface 53 of the frame 51 if it is desirable to fold the frame from the other side.

The moisture control mat 35 can be designed as an integral part of the frame 51 where the mat is not designed to be removed or the absorbent mat can be designed to be removed after a period of use and another mat positioned on the frame 51. When the mat 35 is used as an integral part with the frame 51 the adhesive layer 47 will be designed with properties that securely fix the mat to the first surface 53 of the frame 51. In this configuration it will be very difficult to remove the mat 35 from the frame 51. In applications where the mat 35 is a replaceable component, the adhesive layer 47 will bond the mat 35 to the frame in a less secure manner whereby the mat can be peeled from the frame 51 when it is desired to replace the mat. When a replacement mat is utilized it can be a mat like mat 5 previously discussed in this application. The mat 5 will have a release layer 21 with at least one slit 25 or at least one fold line 31 that corresponds with the fold line 59 in the frame 51. The release layer 21 will be removed from the adhesive layer 17 when the mat is positioned on the frame 51. The adhesive layer 17 will then bond to the first surface 53 of the frame 51 and hold the mat in the desired position on the frame.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

we claim:

1. A moisture control mat comprising:
A moisture control non-woven layer having a first side and a second side; the non-woven layer having a plurality of fibers that wick and distribute fluids over the surface of the non-woven layer;
an adhesive layer disposed on the first side of the non-woven layer, the adhesive layer covering at least a portion of the first side of the non-woven layer;
a release layer positioned on the side of the adhesive layer that is spaced apart from the non-woven layer; and
at least one folding line positioned in the release layer, the at least one folding line defining a fold point for the mat wherein the mat can be folded along the at least one folding line.

2. The mat of claim 1 wherein the second side of the absorbent non-woven layer is disposed for receiving and distributing moisture.

3. The mat of claim 2 wherein the at least one folding line is a slit positioned along a longitudinal centerline of the absorbent mat.

4. The mat of claim 1 wherein more than one slit is positioned in the release layer, each slit defining a folding point for the absorbent mat.

5. The mat of claim 1 wherein the adhesive layer covers at least 50% of the first side of the absorbent non-woven layer.

6. The mat of claim 5 wherein a release layer covers the adhesive layer on the first side of the absorbent non-woven layer.

7. The mat of claim 6 wherein a frame is disposed adjacent the first side of the absorbent non-woven layer, the frame designed to contain the absorbent mat.

8. The mat of claim 7 wherein the frame has at least one fold line whereby the frame can be folded along the at least one fold line, the at least one fold line being disposed in alignment with the at least one slit in the release layer whereby the absorbent mat and the frame fold along the same line.

9. The mat of claim 8 wherein the frame has an outer periphery that defines a ledge, the ledge being disposed to engage an outer periphery of the absorbent non-woven layer whereby the ledge of the frame positions the absorbent non-woven layer with the at least one slit in alignment with the at least one fold line.

10. The mat of claim 1 wherein a strip is positioned in an end of the non-woven layer, the strip being disposed for gripping the mat to assist in removing the mat.

11. The mat of claim 10 wherein the first side of the strip does not have an adhesive layer.

12. The mat of claim 10 wherein the strip has spaced apart areas of adhesive applied to the first surface.

13. The mat of claim 12 wherein the spaced apart areas of adhesive have a bonding strength less than the bonding strength of the adhesive layer.

14. The mat of claim 10 wherein the strip has a width from about 1 to 4 inches.
